(19) United States
(12) Patent Application Publication
(10) Pub. No.: US 2021/0356400 A1
(43) Pub. Date: Nov. 18, 2021

(54) STRESS LUMINESCENCE MEASUREMENT DEVICE AND STRESS LUMINESCENCE MEASUREMENT METHOD

(71) Applicant: Shimadzu Corporation, Kyoto (JP)

(72) Inventors: Yusuke YOKOI, Kyoto (JP); Momoyo YAMAKAWA, Kyoto (JP); Naoya FUJIWARA, Kyoto (JP); Hiroaki TSUSHIMA, Kyoto (JP); Kenta ADACHI, Kyoto (JP)

(21) Appl. No.: 17/317,646

(22) Filed: May 11, 2021

(30) Foreign Application Priority Data
May 13, 2020 (JP) 2020-084530

(51) Int. Cl. G01N 21/70; G01N 3/32; G01L 1/24

(52) U.S. Cl. CPC G01N 21/70; G01L 1/24; G01N 3/32

(57) ABSTRACT

A stress luminescence measurement device according to a first aspect is provided with a load application mechanism configured to deform a sample by applying a load to the sample, a light source configured to emit excitation light to a stress luminescent material 2 arranged on a surface of the sample, a camera configured to image luminescence of the stress luminescent material, and a controller configured to control the load application mechanism, the light source, and the camera. The controller acquires a deformation state of the sample at the imaging timing by the camera and stores the acquired deformation state of the sample in association with the image captured by the camera in a memory.

### CROSS-REFERENCE TO RELATED APPLICATIONS

This application claims priority under 35 U.S.C. § 119 to Japanese Patent Application No. 2020-084530 filed on May 13, 2020, the entire disclosure of which is incorporated herein by reference in its entirety.

### BACKGROUND OF THE INVENTION

### Field of the Invention

The present invention relates to a stress luminescence measurement device and a stress luminescence measurement method.

### Description of the Background Art

In a development side of a flexible device, it is a common practice to verify the durability and the performance of a sample by repeatedly applying a load to the sample using a deformation test instrument. In the above-described test, in a case where the sample has a defect, strain is generated in the periphery of the defect, which may result in a breakage of the sample.

In recent years, as a technique for detecting such a defect, a technique using a stress luminescent material has been proposed. For example, Japanese Unexamined Patent Application Publication No. 2015-75477 discloses a stress luminescence evaluation device for measuring and evaluating the luminescence intensity of a stress luminescent material. In Patent Document 1, a stress luminescent material is placed on a sample, and an external force is applied to the luminescent material together with the sample to cause the stress luminescent to emit light. By imaging the luminescence of the stress luminescent material using the imaging device, the stresses (strains) generated in the sample can be measured.

### SUMMARY OF THE INVENTION

In the above-described strain measurement using a stress luminescent material, it is possible to observe the temporal change in the luminescence of the stress luminescent material due to the change in the external force applied to the sample. However, in order to verify the durability and the performance of the sample, it is required to observe the change in the luminescence of the stress luminescent material in association with an index other than the time-axis, such as, e.g., the change in the shape (e.g., the folding angle of the sample) of the sample. This is because it is useful information when verifying that the strain was generated in the sample when the sample was in a what kind of a deformation state (fold angle).

The present invention has been made to solve the above-described problems. An object of the present invention is to provide a stress luminescence measurement device and a stress luminescence measurement method capable of associating a change in a change of a sample when a load is applied with a change in stress generated in the sample.

A stress luminescence measurement device according to the first aspect of the present invention measures luminescence of a stress luminescent material arranged on a surface of a sample. The stress luminescence measurement device is provided with: a load application mechanism configured to apply a load to the sample to deform the sample; a light source configured to emit excitation light to the stress luminescent material, a camera configured to image the luminescence of the stress luminescent material; and a controller configured to control the load application mechanism, the light source, and the camera. The controller is configured to acquire a deformation state of the sample at an imaging timing by the camera and store the acquired deformation state of the sample and an image captured by the camera in an associated manner in a memory.

A stress luminescence measurement method according to a second aspect of the present invention is a stress luminescence measurement method for measuring luminescence of a stress luminescent material arranged on a surface of a sample. The stress luminescence measurement method includes the steps of:

emitting excitation light to stress luminescent material;

deforming the sample by applying a load to the sample;

imaging the luminescence of the stress luminescent material by a camera;

acquiring a deformation state of the sample at the imaging timing by the camera; and

storing the acquired deformation state of the sample and the captured image by camera in an associated manner in a memory.

The above-described objects and other objects, features, aspects, and advantages of the present invention will become apparent from the following detailed descriptions of the invention that can be understood with reference to the attached drawings.

### BRIEF DESCRIPTION OF THE DRAWINGS

FIG. 1 is a block diagram showing the entire configuration of a stress luminescence measurement device according to Embodiment 1.

FIG. 2 is a diagram for explaining the operation of the load application mechanism shown in FIG. 1.

FIG. 3 is a diagram schematically showing a change in a bending angle of a sample in a bending test of the sample.

FIG. 4 is a block diagram for explaining a functional configuration of a controller.

FIG. 5 is a flowchart for explaining processing procedures of a stress luminescence measurement of a sample using a stress luminescence measurement device according to Embodiment 1.

FIG. 6 is a timing chart for explaining the operations of the light source, the camera, and the holder in the stress luminescence measurement device.

FIG. 7 is a diagram schematically illustrating a captured image acquired by Step S40 of FIG. 5.

FIG. 8 is a graph showing the relation between the average luminescence intensity and the bending angle of the sample in the region-of-interest (ROI).

FIG. 9 is a diagram for explaining a step (S40 in FIG. 5) of calculating the bending angle of the sample in a stress luminescence measurement method according to Embodiment 2.

FIG. 10 is a timing chart for explaining the operations of a light source, a camera, and a holder in a stress luminescence measurement device according to Embodiment 3.

FIG. 11 is a flowchart for explaining processing procedures of a stress luminescence measurement of a sample using a stress luminescence measurement device according to Embodiment 4.

FIG. 12 is a block diagram showing the entire configuration of a stress luminescence measurement device according to Embodiment 5.

FIG. 13 is a diagram schematically showing a change in a captured image acquired in Step S40 of FIG. 5.

FIG. 14 is a graph showing a relation between the average luminescence intensity and the Y-direction length of a sample in the region-of-interest (ROI).

### DESCRIPTION OF THE PREFERRED EMBODIMENT

Hereinafter, some embodiments of the present invention will be described in detail with reference to the attached drawings. The same or corresponding component in the drawings is denoted by the same reference numerals, and the description thereof will not be repeated.

### Embodiment 1

### <Configuration of Stress Luminescence Measurement Device>

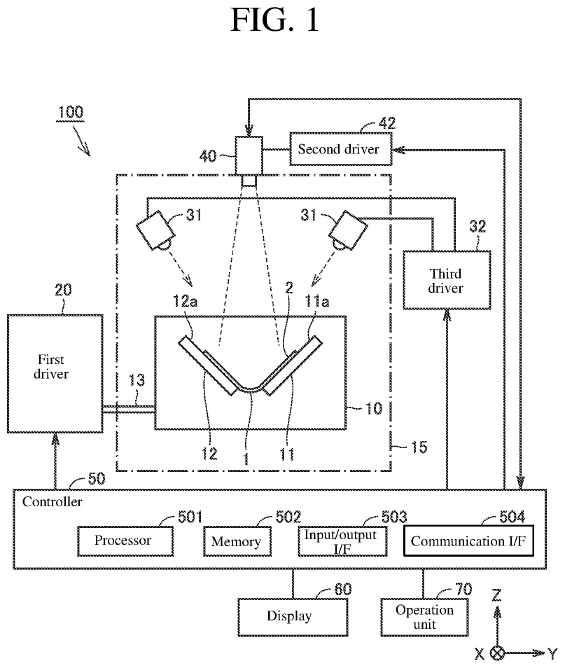

FIG. 1 is a block diagram showing the entire configuration of a stress luminescence measurement device according to Embodiment 1. The stress luminescence measurement device 100 according to Embodiment 1 is a device for measuring the stress (strain) generated in a test target 1 (hereinafter, also simply referred to as “sample”) by using a luminescence phenomenon of a stress luminescent material. The stress luminescence measurement device 100 can also be used to test the durability to the stress generated in a sample 1.

The sample 1 has flexibility and is, for example, a flexible sheet or a flexible fiber. The flexible sheet may, for example, constitute a part of a flexible display or a wearable device of a communication terminal, such as, e.g., a smartphone and a tablet. The flexible fiber may constitute, for example, a part of a optical-fiber cable.

In the example of FIG. 1, the sample 1 is a rectangular flexible sheet. A stress luminescent material 2 is arranged on the sample 1. The stress luminescent material 2 is, for example, a stress luminescent sheet that contains a stress luminescent material and is arranged at least on a predetermined area of the sample 1. This predetermined area is set to include the area (i.e. the deformation area of the flexible sheet) where stress occurs when the flexible sheet is folded. The stress luminescent material 2 is bent integrally with the sample 1 to generate stress.

The stress luminescent material 2 is a member that emits light by a mechanical stimulus from the outside, and a conventionally known member can be used. The stress luminescent material 2 has a property of emitting light by externally applied strain energy, and the luminescence intensity varies according to the strain energy. The stress luminescent material 2 is a solid solution of an element as a luminescence center in a crystal framework, and can emit light at various wavelengths from the ultraviolet light, the visible light, and the infrared light by selecting an inorganic base material and an element as a luminescence center. The typical composition includes defect-controlled strontium aluminate (SrAl₂O₄: Eu, green luminescence) with europium added as luminescence center, zinc sulfide (ZnS: Mn, yellow-orange luminescence) with manganese added as luminescence center, and structure-controlled barium calcium titanate ((Ba,Ca) TiO₃: Pr, red luminescence) with praseodymium added as luminescence center.

The stress luminescence measurement device 100 is provided with a load application mechanism for applying a load to the sample 1. In the example of FIG. 1, the load application mechanism is configured to reproducibly reproduce a load applied to a flexible display during the folding operation for a smartphone.

Specifically, the load application mechanism has a holder 10 and a first driver 20. The holder 10 supports the sample 1 such that the surface of the sample 1 is positioned on the upper side (the upper side of the paper of FIG. 1). The first driver 20 is configured to bend the sample 1 by transitioning the holder 10 between a first position and a second position. For example, a deformation test device disclosed in Japanese Unexamined Patent Application Publication No. 2019-39743 can be applied to such a load application mechanism.

In the example of FIG. 1, the holder 10 has a first mounting plate 11, a second mounting plate 12, and a drive shaft 13. The first mounting plate 11 has a rectangular main surface 11a. The second mounting plate 12 has a rectangular main surface 12a. The sample 1 is attached to the main surface 11a and the main surface 12a with the rear surface of the sample 1 bonded thereto.

The first driver 20 is attached to the base of the drive shaft 13. The drive shaft 13 is rotatably supported with its central axis parallel to the X-axis. The first driver 20 includes a motor, a transmission, and a controller (not shown) therein to rotate the drive shaft 13 forward and backward about its central axis by a predetermined rotation angle and rotation speed. Note that the rotation angle and the rotation speed of the drive shaft 13 are variable. Thus, it is possible to appropriately change the bending angle and the bending speed in the bending test of the sample 1 which will be described later.

The second mounting plate 12 is non-rotatably attached to the drive shaft 13. The second mounting plate 12 rotates in accordance with the rotation of the drive shaft 13. When the second mounting plate 12 rotates, the first mounting plate 11 also rotates.

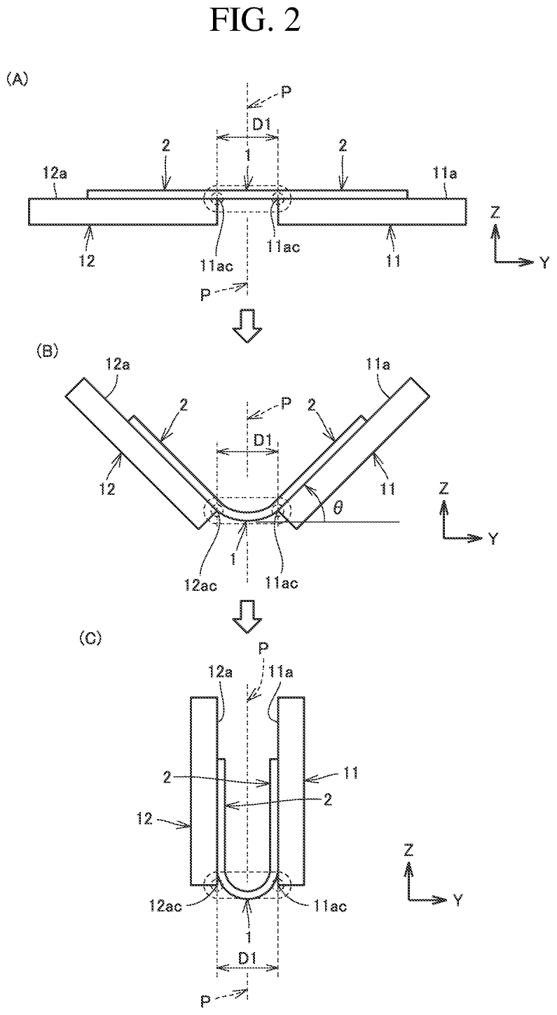

FIG. 2 is a diagram for explaining the operation of the load application mechanism shown in FIG. 1. FIG. 2 shows a state of the first mounting plate 11, the second mounting plate 12, and the sample 1 attached thereto as viewed from the X-axis direction. (B) and (C) of FIG. 2 show states in which the sample 1 is folded from the state of (A) of FIG. 2. The sample 1 has a stress luminescent material 2 placed on the surface of the sample 1.

When the drive shaft 13 is rotated in the positive direction (clockwise direction) about its central axis by the first driver 20 from the state of (A) of FIG. 2, as shown in (B) and (C) of FIG. 2, the sample 1 attached to the main surface 12a and the main surface 11a is bent between the main surface 12a and the main surface 11a which are rotated in plane symmetrical to the P plane about the end portion 12ac and the end portion 11ac which are parallel to each other and the distance D1 therebetween is constant. Therefore, the sample 1 is bent with the substantially the same bending radii at any portion of the sample 1 in the vicinity of the end portion 12ac, the vicinity of the end portion 11ac, and between the end portions 11ac and 12ac.

Further, the load application mechanism of FIG. 1 rotates the main surface 11a and the main surface 12a about the end portion 12ac and the end portion 11ac in a state in which the end portion 12ac and the end portion 11ac are always in parallel to each other and the distance D1 therebetween is kept constant, and therefore the load application mechanism deforms the portion of the sample 1 positioned between the vicinity of the end portion 12ac and the vicinity of the end portion 11ac, but does not substantially deform the remainder of the sample 1.

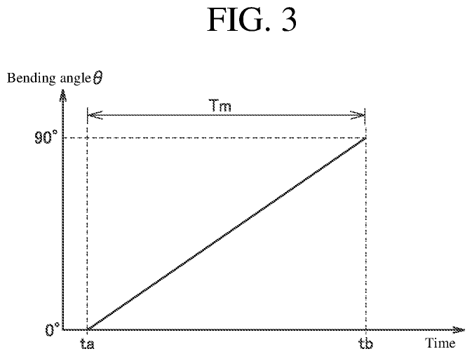

When the bending angle of the sample 1 in FIG. 2 is θ, the bending angle θ in the state of (A) of FIG. 2 (the sample 1 is in a flat state) is 0° (bending angle θ=0°), and the bending angle θ in the state of (C) of FIG. 2 (the sample 1 is in a bent state) is 90° (bending angle θ=90°). FIG. 3 is a diagram schematically showing the change in the bending angle θ of the sample 1 in the bending test of the sample 1. In FIG. 3, the time ta indicates the bending start timing of the sample 1, and the time tb indicates the end timing of the folding of the sample 1. The time Tm from the time ta to the time tb corresponds to the test time of one bending test. During the test time Tm, the bending angle θ of the sample 1 varies between 0° and 90°.

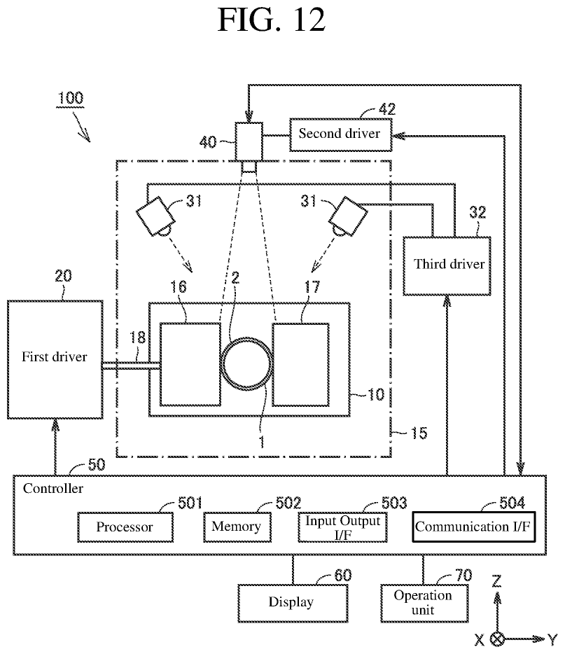

Note that by rotating the sample 1 in the opposite direction (counterclockwise direction) from the state in which the sample 1 is in a bent state ((C) of FIG. 2) by the first driver 20, it returns to the state of (A) of FIG. 2 via the state of (B) of FIG. 2. As described above, by changing from the state of (A) of FIG. 2 (the sample 1 is in a flat state) to the state of (C) of FIG. 12 (the sample is in a folded state) by rotating the drive shaft 13 in the positive direction) and then returning from the state of (C) of FIG. 2 to the state of (A) of FIG. 2 by rotating the drive shaft 13 in the opposite direction (corresponding to one measurement set), the sample 1 is bent from a flat state and returned to the flat state again. Therefore, it is possible to perform a bending test once. By alternately rotating the drive shaft 13 in the forward and reverse directions, the bending test of the sample 1 can be repeatedly performed.

Returning to FIG. 1, the stress luminescence measurement device 100 further includes a light source 31, a housing 15, a camera 40, a second driver 42, a third driver 32, and a controller 50.

The light source 31 is arranged above the sample 1 and is configured to irradiate the stress luminescent material 2 with excitation light. Receiving the excitation light, the stress luminescent material 2 transitions to the light emitting state. Preferably, the excitation light is light having a wavelength range of ultraviolet ray-blue light. As the excitation light, light included in a wavelength range of 10 nm to 600 nm (including UV light to visible light range) can be used. As the light source 31, an ultraviolet ray lamp, an LED (Light Emitting Diode), and the like can be used.

In the embodiment of FIG. 1, it is configured to emit the excitation light to the stress luminescent material 2 from two directions, but the light source 31 may be configured to emit the excitation light to the stress luminescent material 2 from one direction or three or more directions.

The holder 10 and the light source 31 are housed in the housing 15. In a state in which the light source 31 is in an off-state, the housing 15 can be made in a dark room.

The third driver 32 supplies power for driving the light source 31. The third driver 32 can control the quantity of light of the excitation light emitted from the light source 31 and the irradiation time of the excitation light by controlling the power supplied to the light source 31 in response to the command received from the controller 50.

The camera 40 is arranged above the sample 1 such that the stress luminescent material 2 positioned in the predetermined area of the sample 1 is included in the field of view. In the example of FIG. 1, the camera 40 is attached to the ceiling surface of the housing 15. Specifically, the camera 40 is arranged so that the focusing position is positioned at at least one point in the predetermined area of the sample 1. Preferably, at least one point in the predetermined area is positioned at the bending center of the sample 1.

The camera 40 includes optical elements, such as, e.g., a lens, and an imaging element. The imaging element is realized by, for example, a CCD (Charge Coupled Device) sensor and a CMOS (Complementary Metal Oxide Semiconductor) sensor. The imaging element generates a captured image by converting the light incident from the stress luminescent material 2 via the optical system into an electric signal.

The camera 40 is configured to image the luminescence of the stress luminescent material 2 positioned in the predetermined area at the time of the load application to the sample 1. The image data generated by the imaging by the camera 40 is transmitted to the controller 50.

The second driver 42 is configured such that the focusing position of the camera 40 can be changed in response to the command received from the controller 50. Specifically, the second driver 42 can adjust the focusing position of the camera 40 by moving the camera 40 along the Z-axis direction and the Y-axis direction shown in FIG. 1. For example, the second driver 42 has a motor for rotating the feed screw for moving the camera 40 in the Z-axis direction and Y-axis direction and a motor driver for driving the motor. The feed screw is rotatably driven by the motor, so that the camera 40 is positioned at a specified position within a predetermined range in each direction of the Z-axis and the Y-axis. Further, the second driver 42 transmits the positional information indicating the position of the camera 40 to the controller 50.

The controller 50 controls the entire stress luminescence measurement device 100. The controller 50 has, as its main components, a processor 501, a memory 502, an I/O interface (I/F) 503, and a communication I/F 504. These units are connected to each other via a bus (not shown) in a communicable manner.

The processor 501 is typically an arithmetic processing unit, such as, e.g., a CPU (Central Processing Unit) and an MPU (Micro Processing Unit). The processor 501 controls the operation of each unit of the stress luminescence measurement device 100 by reading out and executing a program stored in the memory 502. Specifically, the processor 501 executes a program to realize each of the processing of a stress luminescence measurement device 100, which will be described later. In the example of FIG. 1, a configuration is illustrated in which the processor is configured by a single processor, but the controller 50 may be configured to include a plurality of processors.

The memory 502 is realized by a non-volatile memory, such as, e.g., a RAM (Random Access Memory), a ROM (Read Only Memory), and a flash memory. The memory 502 stores programs to be performed by the processor 501 or data to be used by the processor 501.

The input/output I/F 503 is an interface for exchanging various data between the processor 501, the first driver 20, the third driver 32, the camera 40, and the second driver 42.

The communication I/F 504 is a communication interface for exchanging various types of data between the stress luminescence measurement device 100 and other devices and is realized by an adapter, a connector, or the like. The communication method may be a wireless communication method, such as, e.g., a wireless LAN (Local Area Network) and a wired communication method using a USB (Universal Serial Bus).

To the controller 50, the display 60 and the operation unit 70 are connected. The display 60 is configured by a liquid crystal panel capable of displaying an image. The operation unit 70 accepts the operation input of the user to the stress luminescence measurement device 100. The operation unit 70 is typically configured by a touch panel, a keyboard, a mouse, and the like.

The controller 50 is communicatively connected to the first driver 20, the third driver 32, the camera 40, and the second driver 42. The communication between the controller 50 and the first driver 20, the third driver 32, the camera 40, and the second driver 42 may be realized by radio communication or wired communication.

### <Functional Configuration of Controller 50>

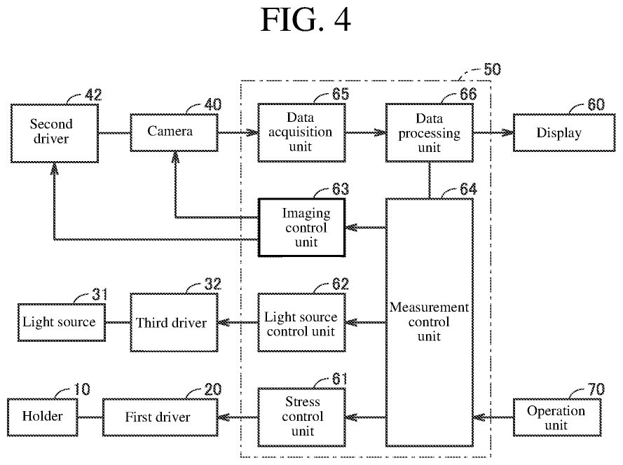

FIG. 4 is a block diagram for explaining the functional configuration of the controller 50.

Referring to FIG. 4, the controller 50 includes a stress control unit 61, a light source control unit 62, an imaging control unit 63, a measurement control unit 64, a data acquisition unit 65, and a data processing unit 66. These are functional blocks implemented based on the execution of the program stored in the memory 502 by the processor 501.

The stress control unit 61 controls the operation of the first driver 20. Specifically, the stress control unit 61 controls the operating speed and the operating time, etc., of the first driver 20 according to the measurement condition set in advance. By controlling the operating speed and the operating time of the first driver 20, it is possible to adjust the rotation angle and the rotation speed of the drive shaft 13 in the holder 10. With this, it is possible to adjust the folding angle and the bending speed, etc., of the sample 1.

The light source control unit 62 controls the driving of the light source 31 by the third driver 32. Specifically, the light source control unit 62, based on the measurement condition set in advance, generates a command for instructing the magnitude of the power supplied to the light source 31 and the duration time of the power supplied to the light source 31, and outputs the generated command to the third driver 32. By controlling the power that the third driver 32 supplies to the light source 31 in accordance with the command, it is possible to adjust, for example, the quantity of light emitted from the light source 31 and the irradiation time of the excitation light.

The imaging control unit 63 controls the moving of the camera 40 by the second driver 42. More specifically, the imaging control unit 63 generates a command for moving the camera 40 in accordance with the movement of the predetermined area of the sample 1, based on the preset measurement condition and the positional information of the camera 40 input from the second driver 42. The imaging control unit 63 outputs the generated command to the second driver 42. By moving the camera 40 in accordance with the command by the second driver 42, the focusing position of the camera 40 can be maintained at at least one point of the predetermined area of the sample 1.

The imaging control unit 63 further controls imaging by the camera 40. Specifically, the imaging control unit 63 controls the imaging by the camera 40 so as to image the sample 1 at least at the time of the load application, according to the measurement condition set in advance. The measurement condition for the imaging includes the frame rate of the camera 40.

The data acquisition unit 65 acquires the image data generated by the imaging by the camera 40 and transfers the acquired image data to the data processing unit 66.

By performing known image processing on the image data acquired by imaging by the camera 40 at the time of the load application, the data processing unit 66 measures the stress luminescence of the stress luminescent material 2. The data processing unit 66, for example, generates an image showing the distribution of the stress luminescence intensity in the stress luminescent material 2. The data processing unit 66 may cause the display 60 to display the measurement result containing an image showing the stress luminescence intensity profile in the captured image and the stress luminescent material 2 by the camera 40.

The measurement control unit 64 integrally controls the stress control unit 61, the light source control unit 62, the imaging control unit 63, the data acquisition unit 65, and the data processing unit 66. Specifically, the measurement control unit 64 gives a control command to each unit, based on the information on the measurement condition and the sample 1 input to the operation unit 70,

### <Stress Emission Measurement Method>

Next, the stress luminescence measurement method of the sample 1 using the stress luminescence measurement device 100 according to Embodiment 1 will be described.

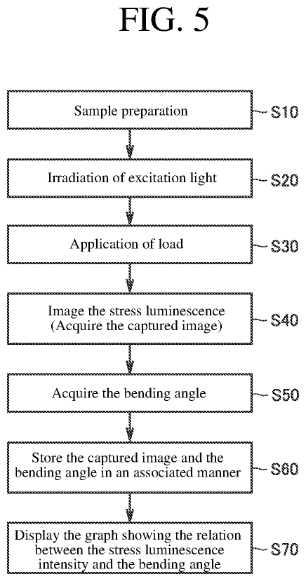

FIG. 5 is a flowchart for explaining the processing procedures of the stress luminescence measurement of the sample 1 using the stress luminescence measurement device 100 according to Embodiment 1.

Referring to FIG. 5, first, a sample 1 is prepared in Step S10. The sample 1 is attached to the main surface 11a of the first mounting plate 11a nd the main surface 12a of the second mounting plate 12 of the holder 10. When folding the sample 1 by the load application mechanism shown in FIG. 1, the deformation area is formed in the central portion in the lateral direction of the sample 1 (Y-direction). This deformation area has a strip-shape extending in the longitudinal direction (X-direction). The stress luminescent material 2 is adhered to the surface of the sample 1 so as to be positioned at least on the deformation area of the sample 1. For example, the stress luminescent material 2 has a rectangular shape of the same size as the sample 1 and is arranged so as to cover the entire surface of the sample 1.

The stress luminescent material 2 can be formed, for example, by bonding a stress luminescent sheet containing a stress luminescent material to a predetermined area of the sample 1. The stress luminescent material 2 is, for example, defect-controlled strontium aluminate (SrAl₂O₄: Eu) to which europium has been added, and shows green luminescence.

Next, in Step S20, the controller 50 emits excitation light (e.g., UV rays) from the light source 31 to the stress luminescent material 2. The stress luminescent material 2 transitions to a light emitting state upon receipt of the excitation light.

Next, the process proceeds to Step S30, the controller 50 applies a load (bending load) to the sample 1 by driving the first driver 20 to bend the sample 1. As shown in FIG. 2, by rotating the drive shaft 13 in the positive direction by the first driver 20, the sample 1 is bent.

Next, in Step S40, the controller 50 images the sample 1 by the camera 40 in accordance with the timing to apply the load to the sample 1. That is, the camera 40 captures the image of the luminescence of the stress luminescent material 2. The imaging by the camera 40 is performed in a dark room. The controller 50 may cause the display 60 to display the acquired captured image.

In Step S50, the controller 50 acquires the bending angle θ of the sample 1 at the imaging timing. Specifically, the data processing unit 66 of the controller 50 calculates the bending angle θ of the sample 1 at the imaging timing, using the change in the bending angle θ at the test time Tm shown in FIG. 3. The calculation of this bending angle θ can be performed by making the imaging start timing by the camera 40 coincide with the bending start timing of the sample 1.

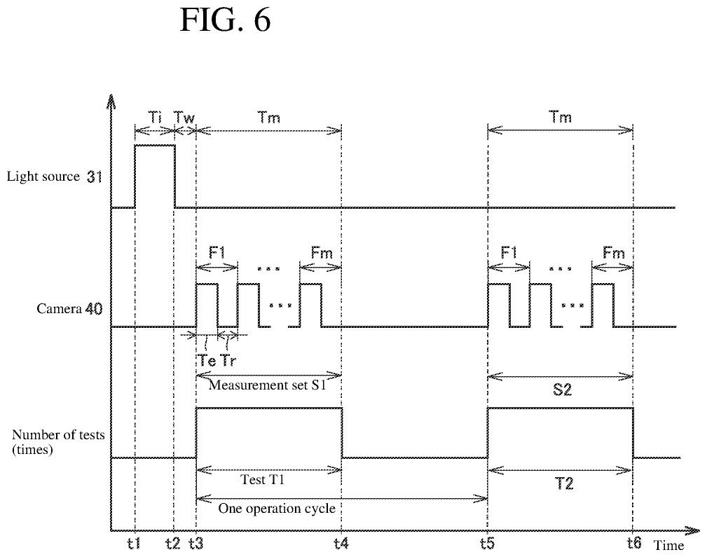

FIG. 6 is a timing chart for explaining the operations of the light source 31, the camera 40, and the holder 10 in the stress luminescence measurement device 100. In FIG. 6, a waveform showing the irradiation timing of the excitation light in the light source 31, a waveform showing the imaging timing of the camera 40, and a waveform showing the operation timing of the holder 10 by the first driver 20 are shown.

The operation timing of the holder 10 is shown by the “number of tests”. The operation of transitioning the sample 1 from the flat state ((A) of FIG. 2) to the folded state ((C) of FIG. 2) is referred to as one bending test (hereinafter, simply referred to as “test”). Therefore, one test is performed in the first half of one operation cycle of the first driver 20. After one test, the sample 1 is returned to the flat state. In the example of FIG. 6, the test is repeated. The first test is also referred to as “T1” and the second test is also referred to as “T2”.

The stress luminescence measurement device 100 measures the luminescence of the stress luminescent material 2 of the sample 1 placed in the predetermined area during the execution of the test. In FIG. 6, the test T1 is started at the time t3. During the time Ti from the time t1 prior to the time t3 to the time t2, excitation light is emitted from the light source 31 to the stress luminescent material 2. The time Tw from the time t2 to the time t3 corresponds to a standby time from the end of the excitation light emittance to the start of the measurement.

At the same time the test T1 is started at the time t3, imaging by the camera 40 is started. That is, the starting timing of the test T1 coincides with the imaging start timing by the camera 40. The imaging by the camera 40 is continuously performed until the time t4 at which the test Ti is completed. That is, the test time Tm from the time t3 to the time t4 corresponds to the measurement time of the stress luminescence.

In the test time Tm (measurement time), the number of still images corresponding to the frame rate of the camera 40 is generated. The frame rate is a frame rate processed per unit time in the moving picture processing. When the exposure time of the camera 40 is Te and the interval time from the exposure to the next frame exposure is Tr, the number of frames can be expressed as m=Tm/(Te+Tr).

In this specification, a set of m frames (still images) acquired by imaging by the camera 40 in a single stress luminescence measurement processing is also referred to as “measurement set”. In FIG. 6, the measurement set acquired by the first stress measurement processing is also referred to as “S1”, and the measurement set acquired by the second stress measurement processing is also referred to as “S2”. Each measurement set is configured by the 1^{st} frame F1 to the m^{th} frame Fm.

During the execution of the stress luminescence measurement processing, the controller 50 (data processing unit 66) calculates the bending angle θ of the sample 1 at the imaging timing (Step S50 in FIG. 5) for each frame F. Specifically, the controller 50 has been acquired the change in the bending angle θ at the test time Tm shown in FIG. 3. in advance as a relational expression or a table. The relational expression and the table represent the relation between the elapsed time t from the test start timing ta and the bending angle θ shown in FIG. 3.

The controller 50 calculates the bending angle θ at each imaging timing of the frames F1 to Fm, using the above-described relational expression or table for each measurement set. Since the imaging start timing of the test start timing coincides with the imaging timing of by the camera 40, each imaging timing of the frames F1 to Fm can be represented by the elapsed time t from the test start timing ta. Therefore, the controller 50 can calculate the bending angle θ at the imaging timing t by referring to the above-described relational expression or table.

Returning to FIG. 5, the controller 50 stores the image data generated by imaging by the camera 40 in Step S60 in the memory 502 in association with the bending angle θ of the sample 1 calculated in Step S50. According to this, when one stress luminescence measurement processing is completed, m pieces of still images are stored in the memory 502 in association with the bending angle θ. Further, when executing the stress luminescence measurement processing a plurality of times, every time the stress luminescence measurement processing is executed, a set composed of m pieces of still images is sequentially stored in the memory 502.

The controller 50 displays the image data generated by the imaging by the camera 40 on the display 60, generates a graph indicating the change in the stress luminescence intensity in the predetermined area of the sample 1, and displays the generated graph on the display 60.

Specifically, in Step S70, the controller 50 generates a graph indicating the relation between the value based on the stress luminescence intensity and the bending angle θ of the sample 1 and displays the generated graph on the display 60.

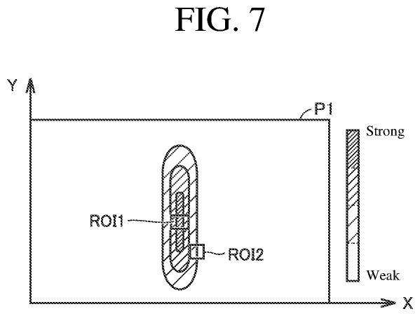

FIG. 7 is a diagram schematically illustrating the captured image acquired in Step S40 of FIG. 5. As shown in FIG. 7, in the captured image P1, the intensity of the luminescence intensity of the stress luminescent material 2 is expressed in brightness on the two-dimensional plane. Note that in the captured image P1, the intensity of the stress luminescence intensity may be represented by at least one of chromaticity, saturation, and lightness. In FIG. 7, the intensity of the stress luminescence intensity is depicted in different hatchings for convenience. Therefore, on the right side of the captured image P1, a bar is shown in which the range of hatching assigned according to the strength of the stress luminescence intensity is shown.

As shown in FIG. 7, in the captured image P1, the stress luminescence pattern appears in a band-shape extending in the longitudinal direction (Y-axis direction) in the central portion (i.e., the bending center portion) in the lateral direction of the stress luminescent material 2 (X-axis direction). This stress luminescence pattern corresponds to the deformation area of the sample 1. Thus, by extracting and analyzing the stress luminescence pattern from the captured image P1, the distortion occurred in the sample 1 can be visualized and quantified.

Specifically, the portion of the stress luminescence pattern where the stress luminescence intensity is large indicates the portion where strain is large, and the portion where the stress luminescence intensity is small indicates the portion where the strain is small. Based on the distribution of the stress luminescence intensity, the distribution of the strain quantity of the sample 1 in the folded state can be visualized and quantified.

The user can set at least one region-of-interest (ROI: Region Of Interest) in the captured image P1 using the operation unit 70 (see FIG. 1). In the example of FIG. 7, two region-of-interests ROI 1 and ROI 2 are set.

For each measurement set, the controller 50 calculates the value based on the luminescence intensity in the ROI for each of frames F1 to Fm. The value based on the luminescence intensity in the ROI can be calculated by statistical processing or typical arithmetic processing of the luminescence intensity in the ROI. In this specification, the controller 50 calculates the average luminescence intensity in the ROI. For each of frames F1 to Fm, the controller 50 generates a graph G1 indicating the relation between the average luminescence intensity and the bending angle θ in the ROI by associating the bending angle θ of the sample 1 calculated by Step S40 with the average luminescence intensity in the ROI.

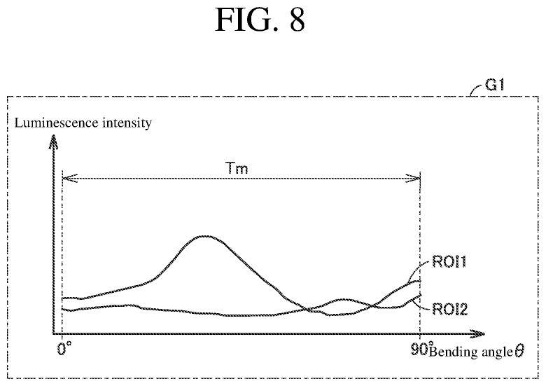

FIG. 8 is a graph G1 showing the relation between the average luminescence intensity and the bending angle θ of the sample 1 in the ROI. The vertical axis of FIG. 8 represents the luminescence intensity, and the horizontal axis represents the bending angle θ of the sample 1. The range of the bending angle θ of the horizontal axis (0°≤θ≤90°) corresponds to the change in the bending angle θ in the test time Tm of FIG. 6. The graph G1 can be generated by plotting the combinations of the bending angle θ calculated for each of frames F1 to Fm and the average luminescence intensity in the ROI.

According to the graph G1, the user can observe the change in the stress luminescence intensity with respect to the change in the bending angle θ. For example, it is possible to detect the bending angle θ at which the stress luminescence intensity is maximized. According to this, it is possible to verify at which bending angle θ the strain has occurred in the sample 1.

Furthermore, among a plurality of measurement sets, it is possible to compare the detected bending angles θ by detecting the bending angle θ at which the stress luminescence intensity becomes maximum. Alternatively, the stress luminescence intensity at the same bending angle θ can be compared among a plurality of measurement sets. With these, it becomes possible to analyze how the stresses occurred in the sample 1 vary with repetition loads.

As described above, according to the stress luminescence measurement device and the stress luminescence measurement method according to Embodiment 1, the change in the bending angle θ of the sample 1 in one test time Tm (see FIG. 3) is acquired in advance as a relational expression or a table, and the test start timing is made to coincide with the imaging start timing by the camera 40. Therefore, the bending angle θ of the sample 1 at each imaging timing of frames F1 to Fm can be acquired by using the above-described relational expression or table for each measurement set. With this, the change in the bending angle θ of the sample 1 when a load is applied can be associated with the change in the stresses occurred in the sample 1.

### Embodiment 2

In Embodiment 1, an example is shown in which based on the relational expression or table (see FIG. 3) acquired in advance, the bending angle θ of the sample at the imaging timing is calculated, but it may be configured to calculate the bending angle θ of the sample 1 from the captured image P1 by the camera 40.

In Embodiment 2, a method of calculating the bending angle θ of the sample 1 from the captured image P1 will be described. Note that in Embodiment 2 and thereafter, the configuration of the stress luminescence measurement device 100 is the same as the configuration of the stress luminescence measurement device 100 shown in FIG. 1, and therefore, the description will not be repeated. Further, since the processing procedures of the stress luminescence measurement are the same as the flowchart shown in FIG. 5 except for a step for acquiring the bending angle θ of the sample 1 (S40 in FIG. 5), the detailed description will not be repeated.

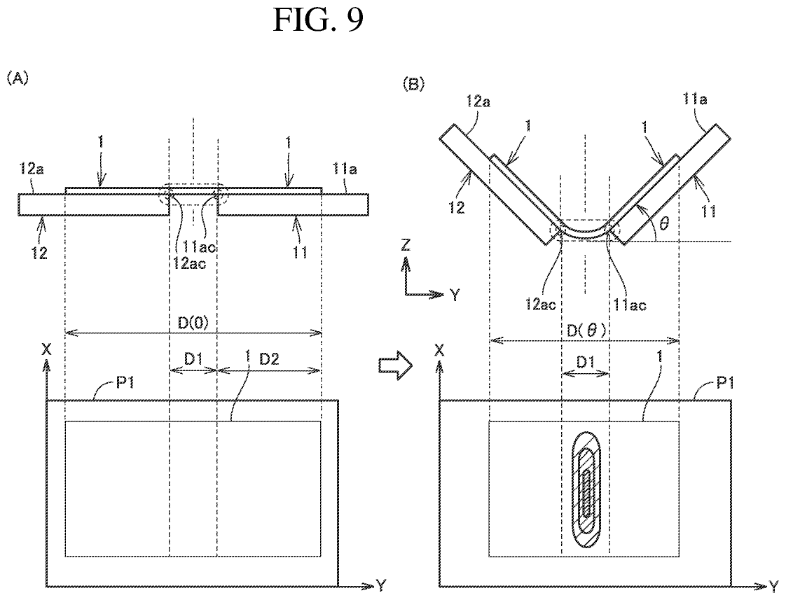

FIG. 9 is a diagram for explaining the step (S40 in FIG. 5) of calculating the bending angle θ of the sample 1 in the stress luminescence measurement method according to Embodiment 2. As shown in (A) of FIG. 9, the sample 1 and its captured image P1 prior to the load application are shown schematically. In (B) of FIG. 9, the sample 1 and its captured image P1 during the load application are shown schematically.

As shown in (A) of FIG. 9, in a state in which no load is applied to the sample 1 (i.e., the state of the bending angle θ=0°), an image of the sample 1 in a flat state appears in the captured image P1. When the length of the sample 1 of a rectangular shape in the lateral direction (Y-direction) when the bending angle θ is 0 (bending angle θ=0°) is D(0), the length D(0) corresponds to the length of the sample 1 in the Y-direction.

Rotating the drive shaft 13 in the positive direction (clockwise direction) about its central axis by the first driver 20 from the state of (A) of FIG. 9, as shown in (B) of FIG. 9, the sample 1 attached to the main surface 12a and the main surface 11a is bent between the main surface 12a and the main surface 11a which rotate in a plane symmetrical to the plane P about the end portion 12ac and the end portion 11ac which are parallel to each other and the distance D1 therebetween is constant. Thus, the luminescence of the stress luminescent material 2 appears in the captured image P1.

When the length of the image of sample 1 in the lateral (Y-direction) in the captured image P1 when the bending angle is θ (θ>0°) is D(θ), D(θ) becomes shorter than D(0) (D(θ)<D(0)). As described above, the lateral direction length of the image of the sample 1 in the captured image P1 varies according to the bending angle θ of the sample 1. In this embodiment, the lateral directional length of the sample 1 decreases as the bending angle θ of the sample 1 increases from 0°. The controller 50 calculates the bending angle θ of the sample 1 based on the lateral direction length D (θ) of the sample 1 in the captured image P1 by utilizing this relation.

Specifically, when the length of the sample 1 positioned on the main surface 11a of the first mounting plate 11 in the Y-direction is D2, the following expression (1) is established between D(0) and D1, D2 when the bending angle θ=0°.

D(θ)=D1+D2×2 (1)

On the other hand, between D(θ) and D1, D2 when the bending angle θ (θ>0°), the relation of the following expression (2) is established.

D(θ)=D1+D2×cos θ×2 (2)

According to the above expressions (1) and (2), cos θ can be expressed by the lengths D(0) and D(θ) and the distances D1 of the sample 1 in the captured image P1 as shown in the following expression (3). According to this, by detecting the length D(θ) of the sample 1 in the captured image P1, it is possible to determine the bending angle θ of the sample 1 based on the detected value.

Cos θ={D(θ)−D1}/{D(0)−D1} (3)

As described above, the stress luminescence measurement device and the stress luminescence measurement method according to Embodiment 2 is configured to calculate the bending angle θ of the sample 1, based on the image of the sample 1 appeared in the captured image P1 by the camera 40. Therefore, for each measurement set, it is possible to determine the bending angle θ of the sample 1 at each imaging timing of frames F1 to Fm, the change in bending angle θ of the sample 1 when a load is applied can be associated with the change in the stress generated in the sample 1. Note that the stress luminescence measurement method according to Embodiment 2 is not required to make the test start timing coincide with the imaging start timing by the camera 40, as in the stress luminescence measurement method according to Embodiment 1.

### Embodiment 3

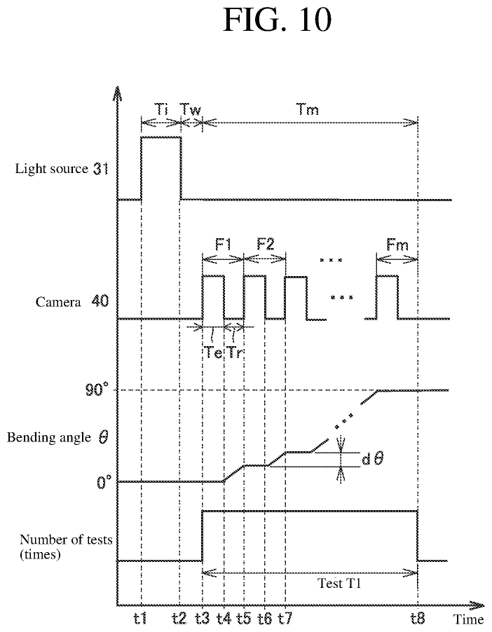

In a stress luminescence measurement method according to Embodiment 3, the imaging timing by the camera 40 is set in accordance with the bending angle θ of the sample 1. FIG. 10 is a timing chart for explaining the operations of the light source 31, the camera 40, and the holder 10 in the stress luminescence measurement device 100 according to Embodiment 3. In FIG. 10, a waveform showing the irradiation timing of excitation light in the light source 31, a waveform showing the imaging timing of the camera 40, and a waveform showing the operation timing of the holder 10 by the first driver 20 are shown.

As shown in FIG. 10, when the imaging by the camera 40 is started at the time t3, the number of still images corresponding to the frame rate of the camera 40 is generated. In Embodiment 3, the test is stopped every frame, and the sample 1 is imaged by the camera 40 in a state in which the bending angle θ is maintained at the stopped timing.

Specifically, by dividing the range of the bending angle θ of the sample 1 (0° to) 90° by the number of frames m, the change amount dθ of the bending angle θ per frame (dθ=90°/m) is set. During the test, the controller 50 incrementally changes the bending angle of sample 1 by dθ. Then, the controller 50 stops the driving of the first driver 20 to maintain the bending angle θ of the sample 1 each time the bending angle of the sample 1 is changed by dθ. During the time in which the first driver 20 maintains the bending angle θ, the controller 50 images the sample 1 by the camera 40.

In the embodiment of FIG. 10, for each frame, the bending angle θ of the sample 1 is changed by dθ in the interval time Tr from the exposure time Te to the following frame exposure. With this, imaging by the camera 40 is performed every time the bending angle θ changes by dθ.

As described above, according to the stress luminescence measurement device and the stress luminescence measurement method of Embodiment 3, by changing the bending angle θ of the sample 1 stepwise and performing imaging by the camera while maintaining its bending angle θ by changing the bending angle θ of the sample 1, it is possible to acquire the bending angle θ of the sample 1 at each imaging timing. According to this, it is possible to associate the change in the bending angle θ of the sample 1 when a load is applied with the change in the stress generated in the sample 1.

### Embodiment 4

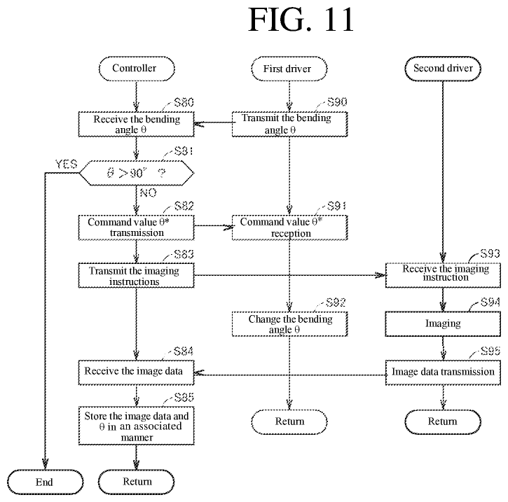

FIG. 11 is a flowchart for explaining the processing procedures of the stress luminescence measurement of the sample 1 using the stress luminescence measurement device 100 according to Embodiment 4. In the stress luminescence measurement method according to Embodiment 4, when the test is started, the controller 50 collectively controls the bending angle θ of the sample 1 and the imaging timing by the camera 40 by communicating with the first driver 20 and the second driver 42. According to this, it is possible to acquire the bending angle θ at each imaging timing.

Referring to FIG. 11, when one test is started, the first driver 20 transmits the bending angle θ of the sample 1 to the controller 50 in Step S90. In Step S80, upon receiving the bending angle θ of the sample 1, in Step S81, the controller 50 determines whether or not the bending angle θ is greater than 90°. When the bending angle θ is greater than 90° (YES in S81), the controller 50 terminates the one test and the imaging by the camera 40.

On the other hand, when the bending angle θ is 90° or less (NO in S81), the controller 50 proceeds to Step S82, calculates the target value θ* of the bending angle θ of the sample 1 and transmits the calculated target value θ* to the first driver 20. In S82, the controller 50 calculates the target value θ* by adding a predetermined change amount dθ to the current bending angle θ.

Subsequently, in Step S83, the controller 50 generates an instruction of the imaging by the camera 40 and transmits the generated imaging instruction to the second driver 42.

Upon receiving the target value θ* from the controller 50 (Step S91), in Step S92, the first driver 20 changes the bending angle θ of the sample 1 so as to coincide with the target value θ*. That is, the first driver 20 changes (increases) the bending angle θ of the sample 1 by dθ.

Upon receiving an imaging instruction from the controller 50 (Step S93), in Step S94, the second driver 42 images the sample 1 by the camera 40. In the captured image by the camera 40, the luminescence of the stress luminescent material 2 at the bending angle θ after the change appears. Proceeding to Step S95, the second driver 42 transmits the image data indicating the captured image of the camera 40 to the controller 50.

Upon receiving the image data from the second driver 42 in Step S84, the controller 50 proceeds to Step S85 and stores the acquired image data and the bending angle θ (corresponding to the command θ*) in the memory 502 in association with each other. Furthermore, in Step S70 of FIG. 5, the controller 50 generates a graph G1 (see FIG. 8) showing the relation between the stress luminescence intensity and the bending angle θ of the sample 1 and displays the generated graph G1 on the display 60.

As described above, according to the stress luminescence measurement device and the stress luminescence measurement method of Embodiment 4, the controller 50 instructs the change in the bending angle θ of the sample 1 with respect to the load application mechanism θ and make the timing to instruct the change in the bending angle θ coincide with the imaging timing by the camera 40, thereby acquiring the bending angle θ of the sample at each imaging timing. According to this, it is possible to associate the change in the bending angle θ of the sample 1 when a load is applied with the change in the stress occurred in the sample 1.

### Embodiment 5

In the above-described stress luminescence measurement method according to Embodiments 1 to 4, an example is shown in which the bending angle of the sample 1 is acquired as the deformation state of the sample 1 when a bending load is applied, but the stress luminescence measurement method according to the present invention can be applied to the configuration in which a load other than the bending load is applied to a sample. For example, according to the stress luminescence measurement methods according to Embodiments 1 to 4, it is possible to obtain the deformation state of the sample 1 when a compression load is applied to the sample 1.

FIG. 12 is a block diagram showing the entire configuration of a stress luminescence measurement device according to Embodiment 5. The stress luminescence measurement device 100 according to Embodiment 5 differs from the stress luminescence measurement device 100 shown in FIG. 1 in the configuration of the load application mechanism. The same portion as the stress luminescence measurement device 100 shown in FIG. 1 will not be repeated.

Referring to FIG. 12, the load application mechanism is configured to apply a compressed load to the sample 1. Specifically, the load application mechanism has a holder 10 and a first driver 20. The holder 10 includes a first support member 16, a second support member 17, and a drive shaft 18. The first support member 16 and the second support member 17 each have a columnar shape, the end portions thereof in the longitudinal direction are arranged to face each other along the Y-direction.

The drive shaft 18 is connected to the first support member 16. The first driver 20 is attached to the base of the drive shaft 18. The first driver 20 is configured to slidably move the drive shaft 18 in the Y-direction to slide the first support member 16 in the Y-direction. The second support member 17 is fixed.

In the sample 1, both ends thereof in the Y-direction are supported by the first support member 16 and the second support member 17. In this state, when the first support member 16 is slid in the Y-direction toward the second support member 17, a compression load is applied to the sample 1. In the example of FIG. 12, the sample 1 is a flat plate member having a circular configuration. A stress luminescent material 2 is arranged on the sample 1. The stress luminescent material 2 is arranged at least on the predetermined area of the sample 1. This predetermined area is set to include the area (i.e., deformation area of the sample 1). where stress occurs when a compression load is applied to the sample 1. The camera 40 is arranged to include the stress luminescent material 2 positioned on the predetermined area of the sample 1 in the imaging field of view.

### <Stress Emission Measurement Method>

Next, a stress luminescence measurement method using the stress luminescence measurement device 100 according to Embodiment 5 will be described. The stress luminescence measurement method according to Embodiment 5 is basically the same as the flowchart shown in FIG. 5 except for the step of acquiring the bending angle of the sample (S50).

The controller 50 drives the first driver 20 to apply a load to the sample 1 (S30 of FIG. 5). By sliding the first support member 16 in the Y-direction by the first driver 20, a compression load is applied to the sample 1.

In Step S40 of FIG. 5, the controller 50 images the sample 1 by the camera 40 in accordance with the timing of applying the load to the sample 1. The camera 40 images the luminescence of the stress luminescent material 2. The controller 50 can display the captured image by the camera 40 on the display 60.

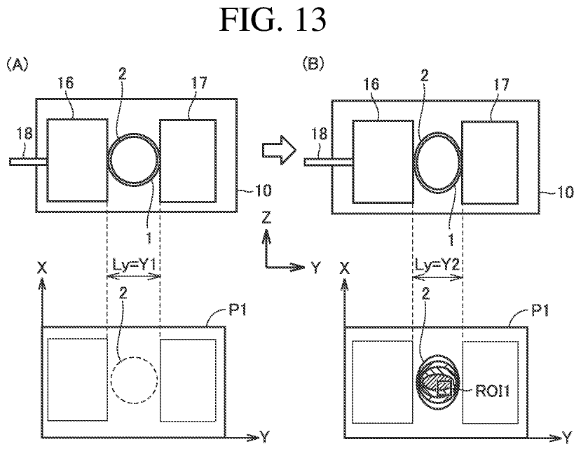

FIG. 13 is a diagram schematically showing the change in the captured image P1 acquired in Step S40 of FIG. 5. (A) of FIG. 13 schematically shows the sample 1 and its captured image prior to the load application. In (B) of FIG. 13, the sample 1 and its captured image during the load application are shown schematically.

(A) of FIG. 13 and (B) of FIG. 13 show a state in which the first support member 16, the second support member 17, and the sample 1 attached thereto are shown as viewed from the X-axis direction. (B) of FIG. 13 shows a state in which a compressed load is applied to the sample 1 from the state of (A) of FIG. 13. As shown in (A) of FIG. 13, in the state in which a compression image is not applied to the sample, the image of the sample 1 in the non-deformed initial state image in the captured image P1.

When the first support member 16 is slid in the Y-direction by the first driver 20 from the state of (A) of FIG. 13, as shown in (B) of FIG. 13, the sample 1 is compressed in the Y-direction and deformed. Therefore, in the captured image P1, the luminescence of the stress luminescent material 2 appears. At this time, as shown in (B) of FIG. 13, the length Ly of the sample 1 in the Y-direction decreases from Y1 to Y2. The deformation amount of the sample 1 by the compressive load in the Y-direction of the sample 1 can be acquired from the displacement amount of the first support member 16 in the Y-direction.

According to this, as described in Embodiment 1, by acquiring the change in the length Ly of the sample 1 in the Y-direction in the test time Tm in advance as a relational expression or a table and making the start timing of the test coincide with the imaging start timing by the camera 40, the controller 50 can calculates the length Ly of the sample 1 in the Y-direction at each imaging timing of the frames F1 to Fm can be calculated, using the relational expression or the table, for each measurement set.

Alternatively, as described in Embodiment 2, by detecting the length of the image of the sample 1 appearing in the captured image P1 by the camera 40 in the Y-direction, it is possible to determine the length Ly of the sample 1 based on the detected value in the Y-direction.

Alternatively, as described in Embodiment 3, by changing the length Ly of the sample 1 in the Y-direction stepwise and performing imaging by the camera while maintaining the length Ly by changing the length Ly in the Y-direction, it is possible to acquire the length Ly of the sample 1 in the Y-direction at each imaging timing.

Alternatively, as described in Embodiment 4, the controller 50 can acquire the length Ly of the sample 1 in the Y-direction at each imaging timing by instructing the load application mechanism to change the length Ly of the sample 1 in the Y-direction and by making the timing instructing the change in the length Ly coincide with the imaging timing by the camera 40.

By acquiring the length Ly of the sample 1 in the Y-direction at the imaging timing using the above-described method, the controller 50 can generates a graph indicating the relation between the luminescence intensity of the stress luminescent material 2 and the length Ly of the sample 1 in the Y-direction. For example, the controller 50 can generate a graph G2 indicating the relation between the average luminescence intensity in the ROI and the bending angle θ by associating the length Ly of the sample 1 in the Y-direction calculated in Step S40 of FIG. 5 with the average luminescence intensity in the ROI for each of frames F1 to Fm.

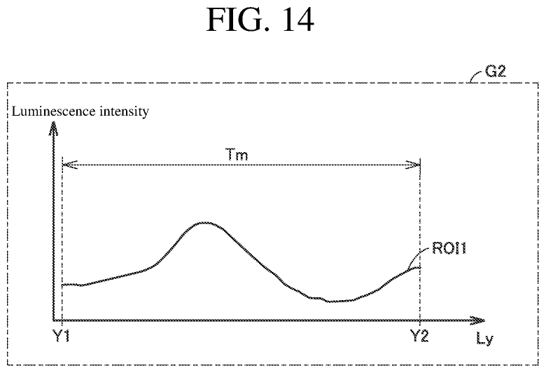

FIG. 14 is a graph G1 showing the relation between the average luminescence intensity in the ROI and the length of the sample 1 in the Y-direction. In FIG. 14, the vertical axis represents the luminescence intensity, and the horizontal axis represents the length Ly of the sample 1 in the Y-direction. The graph G2 can be generated by plotting the combinations of the length Ly of the sample 1 in the Y-direction and the average luminescence intensity in the ROI calculated for each of frames F1 to Fm. According to the graph G2, the user can know the change in the stress luminescence intensity with respect to the change in the length Ly of the sample 1 in the Y-direction.

### [Aspects]

It will be understood by those skilled in the art that the plurality of exemplary embodiments described above is illustrative of the following aspects.

### (Item 1)

A stress luminescence measurement device according to one aspect of the present invention measures luminescence of a stress luminescent material arranged on a surface of a sample. The stress luminescence measurement device includes:

a load application mechanism configured to apply a load to the sample to deform the sample;

a light source configured to emit excitation light to the stress luminescent material;

a camera configured to image the luminescence of the stress luminescent material; and

a controller configured to control the load application mechanism, the light source, and the camera,

wherein the controller is configured to:

acquire a deformation state of the sample at an imaging timing by the camera; and

store the acquired deformation state of the sample and an image captured by the camera in an associated manner in a memory.

According to the stress luminescence measurement device as recited in the above-described Item 1, by acquiring the deformation state of the sample at the imaging timing by the camera, it is possible to observe the change in the stress generated in the sample when a load is applied in association with the change in the form of the sample. With this, it becomes possible to verify whether or not strain has occurred in the sample at what deformation state of the sample.

### (Item 2)

The stress luminescence measurement device as recited in the above-described item 1 further includes a display communicatively connected to the controller.

The controller displays a graph on the display, the graph indicating a relation between a value based on the luminescence intensity acquired from the captured image and the deformation state of the sample.

According to this, by the graph displayed on the display, the user can observe the relation between the change in the luminescence intensity of the stress luminescent material and the deformation state of the sample.

### (Item 3)

In the stress luminescence measurement device as recited in the above-identified item 1 or 2, the controller has acquired a temporal change of the modification of the sample due to a load application by the load application mechanism in advance. The controller is configured to

make a start timing of the load application by the load application mechanism coincide with an imaging start timing by the camera, and

calculate a deformation state of the sample in an elapsed time from the imaging start timing using a temporal change of deformation of the sample.

With this, the deformation state of the sample at the imaging timing by the camera can be acquired.

### (Item 4)

In the stress luminescence measurement device as recited in above-identified item 1 or 2, the controller calculates the deformation state of the sample, based on an image of the sample appearing on a captured image by the camera.

With this, the deformation state of the sample at the imaging timing of the camera can be acquired.

### (Item 5)

In the stress luminescence measurement device as recited in above-identified item 1 or 2, the controller gradually deforms the sample by the load application mechanism and performs imaging by the camera while maintaining the deformation state of the sample every time the sample is deformed.

With this, the deformation state of the sample at the imaging timing of the camera can be acquired.

### (Item 6)

In the stress luminescence measurement device as recited in above-identified item 1 or 2, the controller instructs the application mechanism to change the load to be applied to the sample and makes the timing to instruct the change of the load coincide with the imaging timing by the camera.

With this, the deformation state of the sample at the imaging timing of the camera can be acquired.

### (Item 7)

A stress luminescence measurement method according to one aspect of the present invention is a stress luminescence measurement method for measuring luminescence of a stress luminescent material arranged on a sample, comprising the steps of:

irradiating stress luminescent material with excitation light;

deforming the sample by applying a load;

imaging the luminescence of the stress luminescent material by a camera;

acquiring a deformation state of the sample at the imaging timing by the camera;

storing the acquired deformation state of the sample and the captured image by camera in an associated manner in a memory.

According to the stress luminescence measurement method described in the seventh item, by acquiring the deformation state of the sample at the imaging timing of the camera, it is possible to observe the change in the stress generated in the sample when a load is applied in association with the change in the form of the sample. With this, it becomes possible to verify that the stress has occurred in the sample at what deformation state of the sample.

### (Item 8)

The stress luminescence measurement method as recited in above-identified item 7, further comprising the steps of:

acquiring a value based on the luminescence intensity from the captured image; and

displaying a graph on a display, the graph indicating a relation between the value based on the acquired luminescence intensity and the deformation state of the sample.

According to the graph displayed on the display, the user can observe the relation between the change in the luminescence intensity of the stress luminescent material and the deformation state of the sample.

### (Item 9)

The stress luminescence measurement method as recited in above-identified item 7 or 8,

wherein the step of acquiring the deformation state of the sample includes the steps of:

matching the starting timing of the load application and the imaging start timing by the camera; and

calculating the deformation state of the sample at an elapsed time from the imaging start timing, using a temporal change of the deformation of the sample due to the load application, the temporal change having been acquired in advance.

With this, the deformation state of the sample at the imaging timing of the camera can be acquired.

### (Item 10)

The stress luminescence measurement method as recited in above-identified item 7 or 8,

wherein the step for acquiring the deformation state of the sample includes the step of:

calculating the deformation state of the sample, based on a shape of the sample appearing in the captured image by the camera.

With this, the deformation state of the sample at the imaging timing of the camera can be acquired.

### (Item 11)

In the stress luminescence measurement method as recited in above-identified item 7 or 8,

wherein the step of deforming the sample includes the step of deforming a sample in a stepwise manner, and

wherein the step of acquiring the deformation state of the sample includes a step of performing imaging by the camera while maintaining the deformation state of the sample each time the sample is deformed.

With this, the deformation state of the sample at the imaging timing of the camera can be acquired.

### (Item 12)

In the stress luminescence measurement method as recited in above-identified item 7 or 8,

wherein the step of acquiring the deformation state of the sample includes the steps of:

instructing the load application mechanism to change the load to be applied to the sample; and

making the timing to change the load coincide with the imaging timing by the camera.

With this, the deformation state of the sample at the imaging timing of the camera can be acquired.

Although some embodiments of the present invention have been described, the embodiments disclosed herein are to be considered in all respects as illustrative and not restrictive. The scope of the present invention is indicated by claims, and it is intended to include all modifications within the meanings and ranges equivalent to those of the claims.

1. A stress luminescence measurement device for measuring luminescence of a stress luminescent material arranged on a surface of a sample, comprising:
a load application mechanism configured to apply a load to the sample to deform the sample;
a light source configured to emit excitation light to the stress luminescent material;
a camera configured to image the luminescence of the stress luminescent material; and
a controller configured to control the load application mechanism, the light source, and the camera,
wherein the controller is configured to:
acquire a deformation state of the sample at an imaging timing by the camera; and
store the acquired deformation state of the sample and a captured image by the camera in an associated manner in a memory.

2. The stress luminescence measurement device as recited in claim 1, further comprising:
a display communicatively connected to the controller,
wherein the controller causes the display to display a graph indicating a relation between a value based on luminescence intensity acquired from the captured image and the deformation state of the sample.

3. The stress luminescence measurement device as recited in claim 1,
wherein the controller has acquired a temporal change in a deformation of the sample due to load application by the load application mechanism in advance,
wherein the controller is configured to
make a start timing of the load application by the load application mechanism coincide with an imaging start timing by the camera, and
calculate the deformation state of the sample in an elapsed time from the imaging start timing, using the temporal change in the deformation of the sample.

4. The stress luminescence measurement device as recited in claim 1,
wherein the controller calculates the deformation state of the sample, based on an image of the sample appearing on the captured image by the camera.

5. The stress luminescence measurement device as recited in claim 1,
wherein the controller deforms the sample stepwise by the load application mechanism and performs imaging by the camera while maintaining the deformation state of the sample every time the sample is deformed.

6. The stress luminescence measurement device as recited in claim 1,
wherein the controller instructs the load application mechanism to change the load to be applied to the sample and makes the timing to instruct the change of the load coincide with the imaging timing by the camera.

7. A stress luminescence measurement method for measuring luminescence of a stress luminescent material arranged on a surface of a sample, comprising the steps of:
emitting excitation light to the stress luminescent material;
deforming the sample by applying a load to the sample;
imaging the luminescence of the stress luminescent material by a camera;
acquiring a deformation state of the sample at the imaging timing by the camera; and
storing the acquired deformation state of the sample and the captured image by the camera in an associated manner in a memory.

8. The stress luminescence measurement method as recited in claim 7, further comprising the steps of:
acquiring a value based on the luminescence intensity from the captured image; and
displaying a graph on a display, the graph indicating a relation between the value based on the acquired luminescence intensity and the deformation state of the sample.

9. The stress luminescence measurement method as recited in claim 7,
wherein the step of acquiring the deformation state of the sample includes the steps of:
making the starting timing of the load application coincide with the imaging start timing by the camera; and
calculating the deformation state of the sample in an elapsed time from the imaging start timing, using a temporal change in the deformation of the sample due to the load application, the temporal change having been acquired in advance.

10. The stress luminescence measurement method as recited in claim 7, wherein the step for acquiring the deformation state of the sample includes the step of:
calculating the deformation state of the sample, based on a shape of the sample appearing in the captured image by the camera.

11. The stress luminescence measurement method as recited in claim 7,
wherein the step of deforming the sample includes the step of deforming the sample stepwise, and
wherein the step of acquiring the deformation state of the sample includes a step of performing imaging by the camera while maintaining the deformation state of the sample each time the sample is deformed.

12. The stress luminescence measurement method as recited in claim 7,
wherein the step of acquiring the deformation state of the sample includes the steps of:
instructing the load application mechanism to change the load to be applied to the sample; and
making the timing to change the load coincide with the imaging timing by the camera.
